(19) United States
(12) Patent Application Publication
(10) Pub. No.: US 2015/0264357 A1
(43) Pub. Date: Sep. 17, 2015

(54) METHOD AND SYSTEM FOR ENCODING DIGITAL IMAGES, CORRESPONDING APPARATUS AND COMPUTER PROGRAM PRODUCT

(71) Applicant: STMicroelectronics S.r.l., Agrate Brianza (IT)

(72) Inventor: Daniele Alfonso, Magenta (IT)

(21) Appl. No.: 14/635,612

(22) Filed: Mar. 2, 2015

(30) Foreign Application Priority Data
Mar. 11, 2014 (IT) TO2014A000189

(51) Int. Cl. H04N 19/139; H04N 19/176; H04N 19/54; H04N 19/107

(52) U.S. Cl. CPC H04N 19/139; H04N 19/107; H04N 19/176; H04N 19/54

(57) ABSTRACT

Sequences of digital video images are encoded by dividing the images into coding units encodable with both Intra coding modes and Inter coding modes, detecting whether the coding units belong to the background or to the foreground of the digital video images, and selecting the encoding modes for the coding units belonging to the background out of Inter coding modes by excluding Intra coding modes. The encoding modes for the coding units belonging to the background may be selected out of Inter coding modes with null motion vector, and/or the encoding modes for the coding units belonging to the foreground may be selected out of Intra coding modes by excluding Inter coding modes or out of all the available Intra and Inter coding modes.

### BACKGROUND

1. Technical Field

The present description relates to techniques for encoding digital images. Various embodiments may apply, e.g., to embedded systems such as smart camera devices.

2. Description of the Related Art

In contrast to traditional digital camera systems, which are only able to capture a sequence of digital images (or “pictures”) and to store/transmit them (either in raw or compressed format), smart camera devices include digital signal processing capabilities and are able to perform computer vision tasks to achieve a certain understanding of video content. Some kinds of smart cameras may also be able to ultimately take actions on behalf of the user, for instance by activating an alarm or closing a door when movement is detected.

According to A. N. Belbachir (editor), Smart Cameras, Section 2.2.1 “What is a smart camera?”, pp. 21-23, Springer, 2009, a camera may be defined to be “smart” if possessing the following characteristics:
integration of certain key functions like imaging capture and processing,
use of a processor and software in order to achieve computational intelligence at some level,
ability to perform applications without requiring manual actions.

FIG. 1 shows an exemplary top-level system architecture of a generic smart camera device, including four main blocks:
a SENSE block S, with the capability of capturing image signals (e.g., still images, video frames) from the external world and converting them in to digital form: throughout this description only image sensing, e.g., the capability to acquire 2D digital images will be considered for the sake of simplicity, being otherwise understood that a smart camera may also be capable of acquiring other kinds of signals, like, e.g., audio or environmental data like temperature, humidity, and so on;
a PROCESS block P, with the capability of processing the digital images from the block S and achieving a certain situational “awareness,” e.g., by means of computer vision and machine learning functions, which may be implemented either as dedicated hardware or as software running on a microcontroller or DSP, or possibly as a combination of hardware and software;
a TRANSMIT block T, with the capability of transferring the images and/or the results of their processing, e.g., to other nodes in a network, which may be servers or other camera devices;
a POWER block PW, with the function of providing power to the other blocks.

If a device as exemplified in FIG. 1 is connected to a power grid, consumption may not be a major issue, apart for the necessity of minimizing the overall consumption in those networks including a large number of devices.

A smart camera may be battery operated, and in that case consumption may become a critical element. Transmission may be the function consuming most of the power (e.g., 50%), which makes it a primary candidate for power optimization in minimizing the overall consumption.

A number of implementations will now be discussed in the following by referring to certain references.

A first possible implementation for minimizing power used in transmitting data is to compress the data before transmission. Video compression schemes like MJPEG (Motion JPEG) and especially MPEG/ITU-T standards (the industry-standard H.264/AVC or the emerging H.265/HEVC) can reduce the amount of data to be transmitted by up to two orders of magnitude. See, e.g., ITU-T and ISO/IEC JTC1, “Advanced video coding for generic audiovisual services”, ISO/IEC 14496-10 (MPEG-4 Part 10) and ITU-T Rec. H.264; ITU-T and ISO/IEC JTC1, “High efficiency video coding”, ISO/IEC 23008-2 (MPEG-H Part 2) and ITU-T Rec. H.265. The video compression process may be power-consuming by itself, and certain implementations may be based on a judicious trade-off between compression quality and complexity.

References S.-Y. Chien et al, “Power Consumption Analysis for Distributed Video Sensors in Machine-to-Machine Networks”, IEEE Journal on emerging and selected topics in circuits and systems, Vol. 3, No. 1, March 2013, and R. L. de Queiroz et al, “Fringe benefits of the H.264/AVC”, in proc. of VI International Telecommunications Symposium (ITS 2006), September 2006, discuss two implementations of “no-motion” H.264/AVC encoding, e.g., video encoding by neglecting motion estimation.

A. Krutz et al, “Recent advances in video coding using static background models”, in proc. of 28^{th} Picture Coding Symposium (PCS 2010), December 2010, applies object-based coding to H.264/AVC, based on the concept of “sprite” coding developed years ago for the MPEG-4 standard (see ISO/IEC 14496-2:1999, Information technology—Coding of audio-visual objects—Part 2: Visual); the authors therein propose a modified H.264/AVC bit-stream syntax including background-foreground segmentation as side information, thus requiring a non-standard decoder to process the bit-stream.

J. C. Greiner et al, “Object based motion estimation. A cost-effective implementation”, Nat. Lab. Technical Note 2003/00573, Date of issue: August 2003, Unclassified Report© Philips Electronics Nederland BV 2003, is an unclassified report by Philips R&D describing an implementation of object-based motion estimation, where the moving areas are segmented from the background by means of feature tracking.

A. D. Bagdanov et al, “Adaptive video compression for video surveillance applications”, in proc. of 2011 International Symposium on Multimedia presents a solution where background-foreground segmentation is used to perform adaptive smoothing of the background elements as pre-processing to the H.264 video encoder, allowing to compress foreground objects with higher fidelity.

EP 2 071 514 A2 (also published as US200910154565 A1) is a patent application describing a video encoding system which exploits a background generated image as a reference image for motion estimation and Inter-frame temporal prediction.

### BRIEF SUMMARY

It was observed that video coding standards specify a decoding process and a syntax for the compressed bit-stream. The encoder may not be specified, in that an encoder may be regarded as complying with a certain standard if it produces bit-streams which can be correctly decoded by any decoder device which conforms to the standard specification. Therefore, a certain degree of freedom is left to the designer in designing an encoder in a convenient way.

Also, ITU-T/MPEG standards are essentially asymmetrical: the encoding process may be usually more computationally expensive than the decoding process, e.g., because resources may be dedicated at the encoder side to analyze the input signal to find a best coding technique to compress each coding unit among those available in a standard specification, while such an analysis task is not performed at the decoder side. Consequently, the minimization of the implementation complexity of the video coding process may be a significant point in a device such as a smart camera, which may operate under power-constrained conditions.

It was further observed that video compression is typically lossy, which means that the compressed data may not be exactly identical to the original. Video compression exploits certain characteristics of the human visual system in order to eliminate some high spatial frequencies which would not be visible anyway, thus attaining higher compression with (ideally) acceptable quality degradation.

In an embodiment, a method of encoding a sequence of digital video images includes: dividing the images in said sequence into coding units encodable with both Intra coding modes and Inter coding modes, detecting whether the coding units belong to the background or to the foreground of the digital video images, and selecting the encoding modes for the coding units belonging to the background out of Inter coding modes by excluding Intra coding modes. In an embodiment, the method includes selecting the encoding modes for the coding units belonging to the background out of Inter coding modes with null motion vectors. In an embodiment, the method includes selecting the encoding modes for the coding units belonging to the foreground: out of Intra coding modes by excluding Inter coding modes, out of all the available Intra and Inter coding modes. In an embodiment, detecting whether the coding units belong to the background or to the foreground of the digital video images includes: computing the values of the pixels in said digital video images in a binary mask having the same spatial coordinates of the pixels belonging a current coding unit, by computing a sum of these values, setting a flag indicative of the respective coding unit belonging to the foreground or to the background according to whether the sum reaches or not a certain threshold. In an embodiment, selecting the encoding modes for the coding units belonging to the background includes disabling specific coding modes for a current coding unit. In an embodiment, the method includes: subjecting said coding units to blob extraction and tracking, wherein displacements between the positions of the blobs in subsequent images in said sequence of digital video images are representative of a sparse object-based motion field in a current image, converting said sparse motion field in a block-based motion field, encoding said digital video images by performing the Inter temporal prediction as a function of said block-based motion field. In an embodiment, the method includes initializing the motion estimation process for video encoding using the output of blob tracking of said coding units. In an embodiment, the method includes using the blob displacement information provided by said blob tracking and testing a set of motion vectors in surrounding positions.

In an embodiment, a system for encoding sequences of digital video images includes: an input stage for dividing the images in the sequence into coding units encodable with both Intra coding modes and Inter coding modes, detector stages for detecting whether the coding units belong to the background or to the foreground of the digital video images, and a selector for selecting the encoding modes for the coding units belonging to the background out of Inter coding modes by excluding Intra coding modes. In an embodiment, the system includes a video capture device for producing sequences of digital video images for encoding.

In an embodiment, a computer program product loadable into the memory of at least one computer includes software code portions for implementing an embodiment of one or more of the methods disclosed herein.

One or more embodiments may refer to a corresponding system, to corresponding apparatus including an image capture device in combination with such a system as well as to a computer program product that can be loaded into the memory of at least one computer and comprises parts of software code that are able to execute the steps of the method when the product is run on at least one computer. As used herein, reference to such a computer program product is understood as being equivalent to reference to a computer-readable medium containing instructions for controlling the processing system in order to co-ordinate implementation of a method according to one or more embodiments. Reference to “at least one computer” is evidently intended to highlight the possibility of the present embodiments being implemented in modular and/or distributed form.

One or more embodiments may involve computer vision functions which are available in smart camera devices in order to minimize the implementation cost of the video encoder while achieving good compression performance.

In one or more embodiments, image encoding may be implemented in conformance with existing video coding standards, e.g., by using a video coder system tailored to exploit the specific characteristics of smart cameras.

One or more embodiments may apply to smart cameras operated under power-constrained conditions (e.g., battery power supply).

One or more embodiments may exploit both Intra and Inter prediction, with improved compression efficiency in conjunction with an implementation cost similar to the cost for an Intra-only encoder.

In an embodiment, a method comprises: dividing a sequence of digital video images into coding units; classifying coding units into background coding units and foreground coding units; selecting encoding modes for coding units from a set of available encoding modes including a subset of Inter encoding modes having null motion vectors and a subset of Intra encoding modes, wherein encoding modes selected for coding units classified as background coding units are selected from the subset of Inter encoding modes having null motion vectors; and encoding coding units using selected encoding modes. In an embodiment, the method comprises: selecting encoding modes for coding units classified as foreground encoding units from the subset of Intra encoding modes. In an embodiment, the method comprises: selecting encoding modes for coding units classified as foreground encoding units from the set of available encoding modes. In an embodiment, the method comprises: summing values of pixels of a coding unit; comparing the sum to a threshold value; and classifying the coding unit based on the comparison. In an embodiment, the selecting encoding modes for coding units classified as background coding units includes disabling specific coding modes of the subset of Inter encoding modes for a current coding unit. In an embodiment, the method comprises: applying blob extraction and tracking to frames of the sequence of digital video images; generating a block-based motion field based on the blob extraction and tracking; and encoding at least some coding units of the sequence of digital video images using Inter temporal prediction based on the block-based motion field. In an embodiment, the method comprises: initializing video-encoding motion estimation based on the blob tracking. In an embodiment, the method comprises: testing a set of motion vectors based on the blob tracking.

In an embodiment, a device comprises: an input configured to receive digital video images; and image processing circuitry configured to: divide digital video images into coding units; classify coding units into background coding units and foreground coding units; select encoding modes for coding units from a set of available encoding modes including a subset of Inter encoding modes having null motion vectors and a subset of Intra encoding modes, wherein the image processing circuitry is configured to select encoding modes for coding units classified as background coding units from the subset of Inter encoding modes having null motion vectors; and encode coding units using selected encoding modes. In an embodiment, the image processing circuitry is configured to select encoding modes for coding units classified as foreground encoding units from the subset of Intra encoding modes. In an embodiment, the image processing circuitry is configured to select encoding modes for coding units classified as foreground encoding units from the set of available encoding modes. In an embodiment, the image processing circuitry is configured to: sum values of pixels of a coding unit; compare the sum to a threshold value; and classify the coding unit based on the comparison. In an embodiment, the image processing circuitry is configured to selectively disable encoding modes of the subset of Inter encoding modes for coding units classified as background coding units. In an embodiment, the image processing circuitry is configured to: apply blob extraction and tracking to frames of a sequence of digital video images; generate a block-based motion field based on the blob extraction and tracking; and encode at least some coding units of the sequence of digital video images using Inter temporal prediction based on the block-based motion field. In an embodiment, the image processing circuitry is configured to: initialize video-encoding motion estimation based on the blob tracking. In an embodiment, the image processing circuitry is configured to: test a set of motion vectors based on the blob tracking.

In an embodiment, a system comprises: an image capture device configured to capture a sequence of video images; and image processing circuitry coupled to the image capture device and configured to: divide the sequence of digital video images into coding units; classify coding units into background coding units and foreground coding units; select encoding modes for coding units from a set of available encoding modes including a subset of Inter encoding modes having null motion vectors and a subset of Intra encoding modes, wherein the image processing circuitry is configured to select encoding modes for coding units classified as background coding units from the subset of Inter encoding modes having null motion vectors; and encode coding units using selected encoding modes. In an embodiment, the image processing circuitry is configured to select encoding modes for coding units classified as foreground encoding units from the set of available encoding modes. In an embodiment, the image processing circuitry is configured to: sum values of pixels of a coding unit; compare the sum to a threshold value; and classify the coding unit based on the comparison. In an embodiment, the image processing circuitry is configured to: apply blob extraction and tracking to frames of the sequence of digital video images; generate a block-based motion field based on the blob extraction and tracking; and encode at least some coding units of the sequence of digital video images using Inter temporal prediction based on the block-based motion field.

In an embodiment, a non-transitory computer-readable medium's contents configure an image processing device to perform a method, the method comprising: dividing a sequence of digital video images into coding units; classifying the coding units into background coding units and foreground coding units; selecting encoding modes for coding units from a set of available encoding modes including a subset of Inter encoding modes having null motion vectors and a subset of Intra encoding modes, wherein encoding modes selected for coding units classified as background coding units are selected from the subset of Inter encoding modes having null motion vectors; and encoding the coding units using the selected encoding modes. In an embodiment, the method comprises selecting encoding modes for coding units classified as foreground encoding units from the subset of Intra encoding modes. In an embodiment, the method comprises: summing values of pixels of a coding unit; comparing the sum to a threshold value; and classifying the coding unit based on the comparison. In an embodiment, the method comprises: applying blob extraction and tracking to frames of the sequence of digital video images; generating a block-based motion field based on the blob extraction and tracking; and encoding at least some coding units of the sequence of digital video images using Inter temporal prediction based on the block-based motion field.

### BRIEF DESCRIPTION OF THE SEVERAL VIEWS OF THE FIGURES

One or more embodiments will now be described, purely by way of non-limiting example, with reference to the annexed figures, wherein:

FIG. 1 has been already discussed in the foregoing;

FIG. 2 is an exemplary block diagram of a video encoder;

FIG. 3 is an exemplary block diagram of an intra-only video encoder;

FIG. 4 is schematically representative of movement detection;

FIG. 5 is schematically representative of movement tracking;

FIG. 6 is a block diagram exemplary of one or more embodiments;

FIG. 7 is an exemplary block diagram of a simplified video encoder of an embodiment;

FIG. 8 is a flowchart exemplary of possible processing in one or more embodiments;

FIG. 9 is a block diagram exemplary of one or more embodiments; and

FIG. 10 is a flowchart exemplary of possible processing in one or more embodiments.

### DETAILED DESCRIPTION

In the ensuing description various specific details are illustrated, aimed at providing an in-depth understanding of various examples of embodiments. The embodiments may be obtained without one or more of the specific details, or with other methods, components, materials, etc. In other cases, known structures, materials, or operations are not illustrated or described in detail so that the various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in various points of the present description do not necessarily refer to one and the same embodiment. Moreover, particular conformations, structures, or characteristics may be combined in various ways in one or more embodiments.

Also, some or all of the modules/functions exemplified herein may be implemented in hardware, software, firmware, or a combination or subcombination of hardware, software, and firmware. For example, some or all of these module/functions may be implemented by means of a computing circuit, such as a microprocessor or microcontroller, that executes program instructions, or may be performed by a hardwired or firmware-configured circuit such as an ASIC or an FPGA.

The references used herein are provided merely for the convenience of the reader and hence do not define the sphere of protection or the scope of the embodiments.

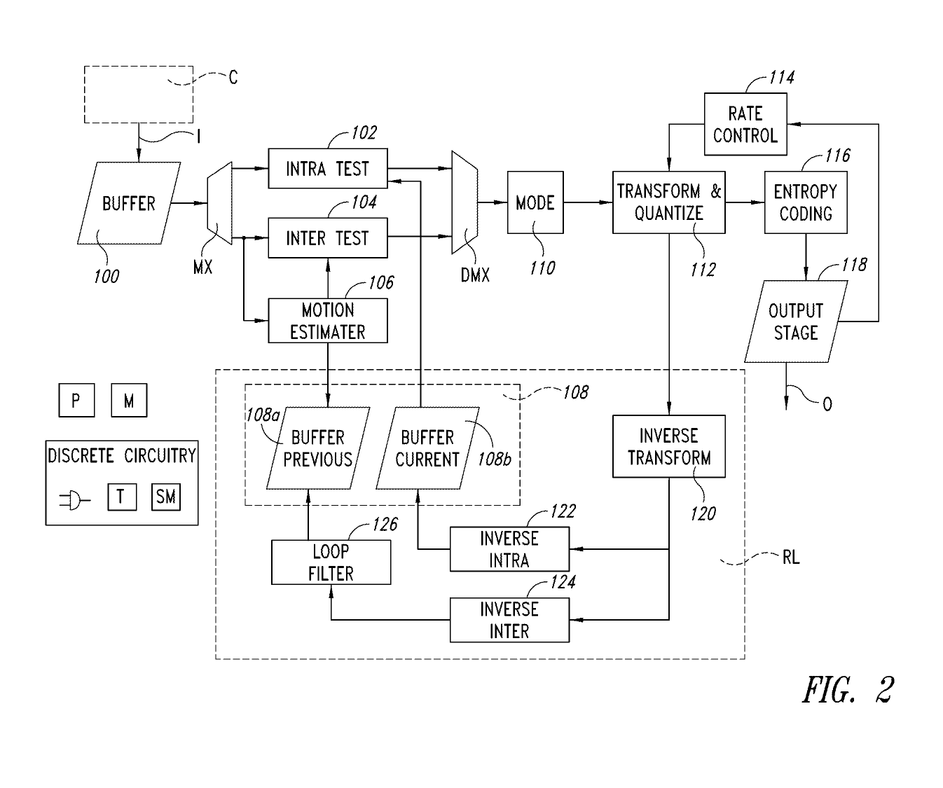

FIG. 2 shows an exemplary top-level architecture of a video encoding system employing Intra-frame and Inter-frame coding.

In such an exemplary architecture each image (frame) in an input digital video sequence I is divided in a set of coding units, which may then be encoded (compressed) by using Intra or Inter prediction. That is, these coding units may be encodable with both Intra coding modes and Inter coding modes, namely with coding modes selected out of Intra coding modes and Inter coding modes.

Intra-frame coding techniques (Intra coding modes) operate on data contained in the current frame only, possibly employing spatial prediction. An image which has been encoded by using only Intra-frame coding can be decoded independently of other images contained in the bit-stream resulting from the encoding process and is called an Intra image.

Inter-frame coding techniques (Inter coding modes) operate via temporal prediction, by referencing data from other images of the video sequence. Each coding unit (or part of it) is thus compressed as predicted data plus residual, where the predicted data come from a previously co-decoded reference image, and are pointed by a “motion vector” which expresses the displacement between the coordinates of the current coding unit being compressed and the predictor in the reference image. A motion vector may generally have sub-pixel accuracy, so that the reference image data are interpolated to construct the predictor, which implies further computation.

The process of finding the optimal motion vector for a given coding unit (or part of it) is called motion estimation, and can be implemented in a number of different ways. Motion estimation may be expensive from the computational viewpoint. It has been an intensive field of research for a long time, and many different motion estimation methods have been proposed over the years.

The exemplary architecture as represented in FIG. 2 includes circuitry to implement the following modules/functions.
Input buffer 100: a memory containing the input data, coming, e.g., from an image capture device C as may be the case for a smart camera. The input buffer 100 is generally exemplary of an input stage where a current image (frame) I may be split into coding units. As used herein, a coding unit will denote any partition of any image which may then be individually compressed. Coding units may be arrays of pixels having a square shape. For instance, in H.264, they are called macroblocks and have 16×16 pixels size.
Intra test 102 and Inter test 104: these stages, fed, e.g., via a multiplexer circuit/function MX from the input buffer 100, may test the various Intra-frame and Inter-frame coding modes available to compress the current coding unit and compute a cost function for each of them.
Motion estimation 106: in the case of Inter-frame compression, this stage may compute an optimal motion vector for the current coding unit or a part of it.
Decoded Images Buffer (DPB) 108: the DPB may include two memories; a previous images memory 108a (to contain one or more previously coded images of the video sequence, which can be used as references for temporal prediction in Inter-frame compression), and a current image memory 108b (to contain the previous coding units of the current image being compressed, to be used as reference for spatial prediction in Intra-frame coding modes).
Mode decision 110: this stage, fed, e.g., via a multiplexer stage DMX from Intra test 102 and Inter test 104 stages, may determine the best coding technique for a current coding unit (or part of it).
Transform and quantize stage 112: this stage may transform the residual of Intra or Inter prediction in the spatial frequency domain by, for example, DCT (Discrete Cosine Transform) or other similar transforms. The transformed residual may then be quantized to eliminate high frequencies which are less visible to the human eye.
Rate control 114: this stage may modulate the quantization step to prevent overflow and underflow of the output buffer, while facilitating attaining constant bit-rate or constant quality in the compressed bit-stream.
Entropy coding 116: this stage may facilitate reducing statistical redundancy in a stream of data, such as Huffman of Arithmetic Coding.
Output buffer 118: this memory may contain the compressed output data O before these are, e.g., transmitted through the channel or stored in a memory.
Inverse quantize and transform 120: this stage may reconstruct the prediction residual by inverting the quantize and transform operations; while the transform may be exactly invertible, quantization may imply loss of quality.
Inverse Intra/Inter prediction 122, 124: these stages may invert the Intra or Inter prediction used to compress the current coding unit, thus reconstructing the pixels. Reconstructed images may be placed in a decoded images buffer to be used as reference for spatial (Intra) or temporal (Inter) prediction of successive coding units.
Loop filter 126: an optional filter may be placed in the reconstruction loop RL including the circuits/functions 108, 120, 122, 124, 126 to improve the quality of the reference images, for instance by smoothing the blocking artifacts.

The system of FIG. 2 may comprise circuitry such as one or more processors P, one or more memories M, discrete circuitry DC, such as one or more logic gates, transform circuits, controllers, state machines, buffers, multiplexers, adders, etc., which may be used alone or in various combinations to implement various functionality of the system. Details of the components of an encoder as shown in FIG. 2 may be held to be otherwise conventional, thus making it unnecessary to provide a more detailed description herein.

Video encoders may devote a significant amount of resources in analyzing an input signal in order to determine an optimal coding mode for each coding unit.

Computationally expensive stages in a video encoder may include the following:
a motion estimation stage, which may compute, e.g., a plurality of SAD (Sum of Absolute Differences) measures for each motion vector tested for a given coding unit;
an Intra and Inter test stage, which may compute a cost function for various possible coding modes considered for a given coding unit.

In resource-constrained applications (e.g., smart cameras), the complexity of the two above-mentioned stages may militate against a cost-effective implementation, so that an Intra-only encoder may be often employed.

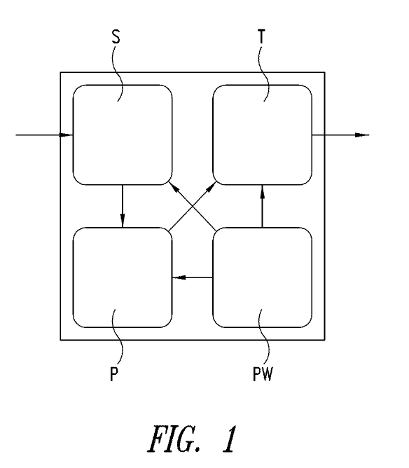

FIG. 3 is an exemplary block diagram of such an encoder. In FIG. 3, circuits/functions corresponding to circuits/functions already discussed in connection with FIG. 2 are denoted with the same reference numerals. A corresponding description will not be repeated here for the sake of conciseness, being otherwise understood that circuits/functions indicated by a same reference numeral in FIGS. 1 and 2 need not necessarily be implemented in the same way.

In brief, an encoder as exemplified in FIG. 3 may not employ temporal prediction, so that Inter test and motion estimation stages (104 and 106 in FIG. 2) may be dispensed with.

A reconstruction loop RL (including, e.g., an inverse quantize and transform stage 120, and an Intra prediction stage 122 to feed a current image buffer 108b) may still be present in case Intra coding is performed by spatial prediction, e.g., by referencing data from previous coding units in the same image or even from previous partitions in the same coding unit. Conversely, if Intra coding does not employ spatial prediction, a reconstruction loop RL may be dispensed with.

The complexity of an Intra-only encoder may be lower than the complexity of an encoder exploiting both Intra-frame and Inter-frame prediction. While the compression efficiency may be correspondingly lower, e.g., up to one order of magnitude, and thus sub-optimal, Intra-only encoding may be employed in smart camera applications such as surveillance or automotive, due to reduced implementation complexity and cost.

One or more embodiments may facilitate providing a video encoder exploiting both Intra and Inter prediction with an implementation cost similar to the cost of an Intra-only solution.

As explained previously, smart camera devices may have the capability of analyzing a captured video and extracting meaningful information from it. This information can be used to trigger events or can be passed to human users or to a machine with, e.g., computational capabilities for higher-level processing.

One or more exemplary embodiments will be discussed in the following by referring for the sake of simplicity to a smart camera device assumed to be in a static physical position.

One or more embodiments may apply to cameras having panning and tilting capabilities, or cameras mounted, e.g., on moving vehicles, with circuitry provided to compensate for the overall movement. Such circuitry may be configured to employ, e.g.:
global motion estimation, e.g., a class of techniques for computing a single motion vector related to a whole image;
visual odometry, e.g., a process of determining the position of a device by analyzing the associated camera images and optical flow computation;
inertial MEMS (Micro Electro Mechanical Systems) sensors, which may also be used for determining the position and orientation by means of “sensor fusion” processing which combine signals from digital gyroscopes, magnetometers and accelerometers.

Once measured, the camera “ego-motion” may be compensated for in a pre-processing stage so that the moving camera case may fall back to the static camera case, where the significant movements may be assumed to be associated to the objects in the foreground.

The following may be noted by way of general introduction to the description of one or more exemplary embodiments.

Movement detection is one of the analysis functions which may be implemented by a smart camera arrangement. A device able to detect movement may be used for instance to monitor an outdoor or indoor environment and trigger an alarm event when detecting an unexpected presence. The device may also be configured to start video transmission when an anomalous event is detected, and save transmission and compression power in the absence of any event of interest. Moreover, movement detection may be a basic function supporting higher-level processing, such as, e.g., movement tracking.

Movement detection may involve separating the foreground and background in digital images (e.g., video frames) and distinguishing between foreground movement (which may be the one of interest) and background movement (which may be caused by waving trees, changes in shadows and illumination, cluttering curtains and so on).

Movement detection may involve two main steps: background modeling and background subtraction.

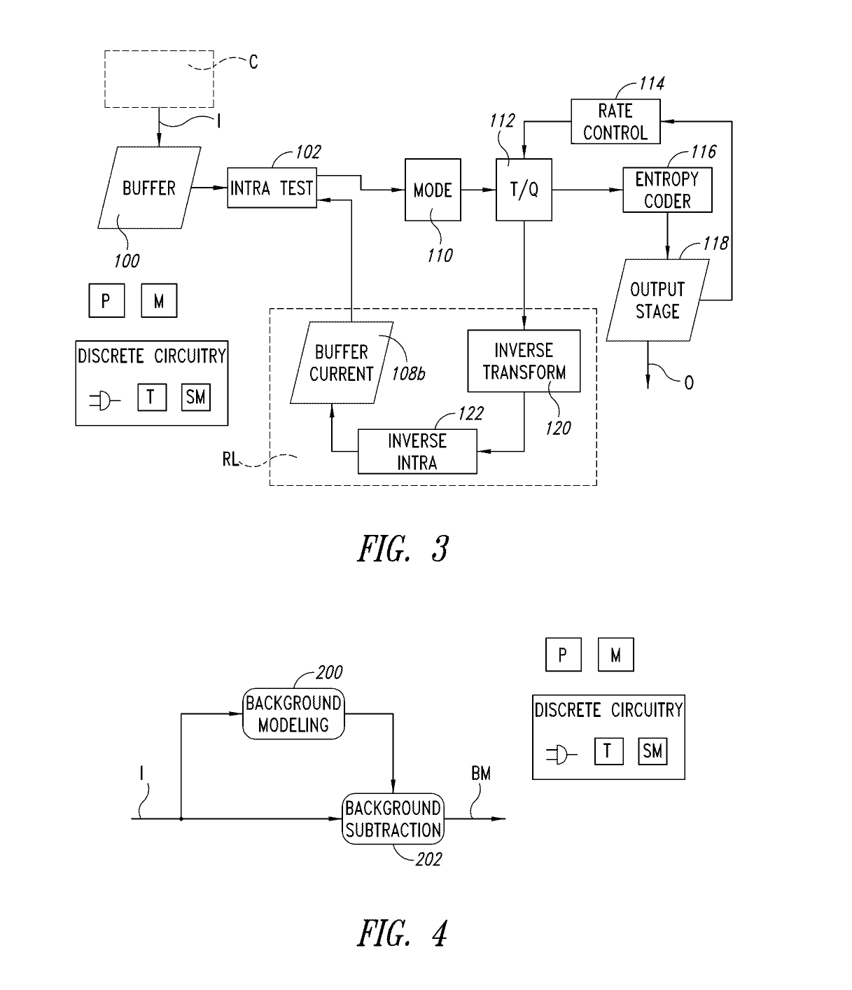

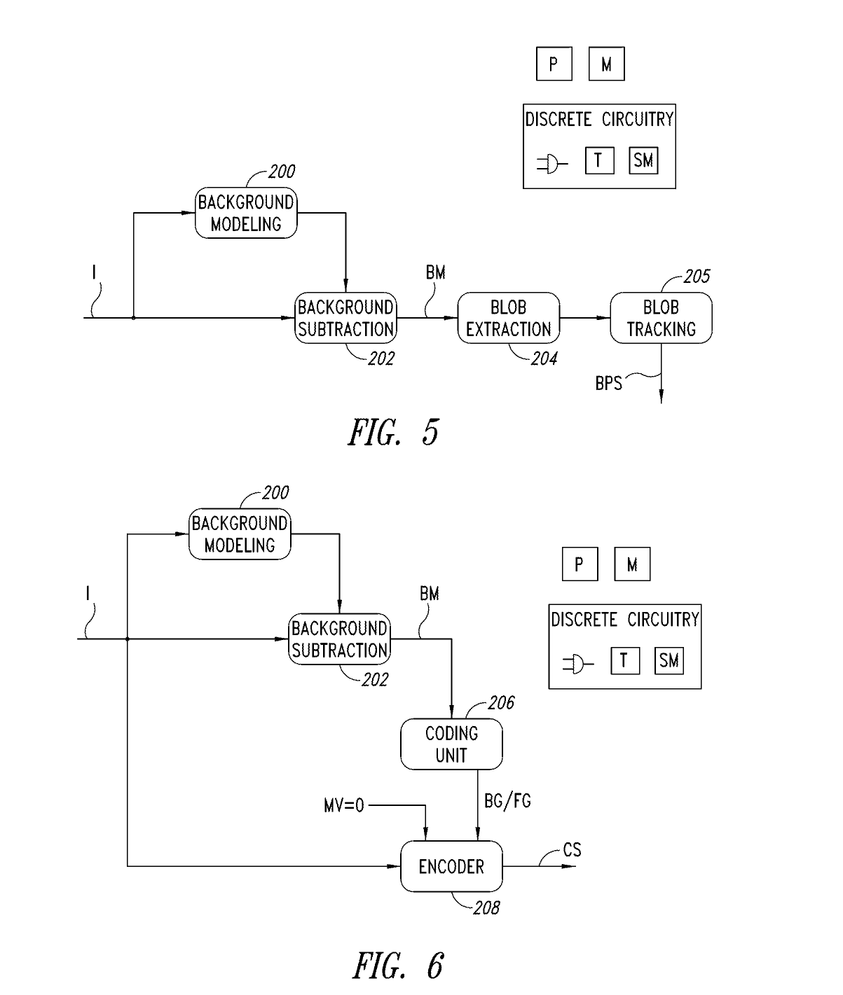

As schematically represented in FIGS. 4 and 5, background modeling 200 may be intended to build a “clean” model of the background of a scene (current image/frame I), by eliminating all the moving objects therein.

This function may be implemented in several ways.

A simple method is a “running average”, which may be expressed as:

b[x,y,t]=α·c[x,y,t]+(1−α)·b[x,y,t−1],

where

b=background image,

c=current image at time instant t,

(x,y)=pixel coordinates,

T=time instant,

α<<1 is a multiplicative constant.

Sophisticated techniques such as, e.g., a Gaussian Mixture Model (GMM) or others can provide better background models at the expense of more complex computation.

As schematically represented in FIGS. 4 and 5, background subtraction 202 may be intended to subtract the current image from a learnt background model, in order to extract the foreground objects, e.g., by using a kind of segmentation.

A straightforward way to implement background subtraction is a simple pixel difference, which may be exposed to false positives at various locations. False positives may be filtered out by means of morphological filtering and thresholding, e.g., to produce as an output a monochromatic image where black pixels correspond to the background and white pixels correspond to the foreground. If all the output pixels are black, no movement may be assumed, otherwise movement is detected.

Movement tracking is a computer vision function which may be implemented by certain smart camera devices. While movement detection may activate an alarm, e.g., in case of whatever foreground movement is detected, movement tracking may aim at reconstructing the trajectory of moving objects in order to allow more elaborated understanding of the video contents, e.g., activating an alarm if an object crosses a line representing a fence.

With respect to movement detection, tracking may involve additional processing stages, such as, e.g., blob extraction and blob tracking.

As schematically represented in FIG. 5, blob extraction 204 may be intended to identify connected regions in the binary mask BM produced by the background subtraction, in order to locate the “blobs” corresponding to the various moving objects in the scene and mark their position for instance by a bounding box identified by top-left and bottom-right corners, or alternatively by its centroid coordinates and its width and height dimensions.

As schematically represented in FIG. 5, blob tracking 205 may be intended to find a correspondence between blobs at frames (k−1) and blobs at frame (k), providing as an output the spatial coordinates (e.g., blob positions and speeds BPS) of each blob for each frame of the sequence. Blob tracking 205 may employ estimators like a Kalman filter, conceived for estimating the state of a system from a series of noisy measures. Particle filter may be another viable approach.

The systems of FIGS. 4 and 5 may comprise circuitry such as one or more processors P, one or more memories M, discrete circuitry DC, such as one or more logic gates, transform circuits, state machines, etc., which may be used alone or in various combinations to implement various functionality of the systems.

In the following, various examples of embodiments of low-complexity video encoders for smart camera devices will be described.

One or more embodiments may be based on the recognition that a significant part of the implementation complexity of a video encoder may be related to motion estimation and coding unit mode decision.

One or more embodiments may be based on the recognition that:
motion estimation may be replaced by a simple “no-motion estimation” stage, which is only able to evaluate the null motion vector, e.g., the one having (0,0) coordinates, which points to a predictor having the same spatial coordinates of the current coding units in the reference frame. This makes it possible to avoid, e.g., computation of SAD metrics and a sub-pixel interpolation process, thus saving an appreciable amount of computation in comparison with a conventional encoder with a complete motion estimation procedure; and/or
for each coding unit (CU), a mode decision stage may receive a Boolean flag from a “CU selection” stage, indicating whether the current coding unit belongs to the background (BG) or to the foreground (FG); this BG/FG flag may be computed, e.g., by computing a sum of the values of the pixels in a binary mask BM having the same spatial coordinates of the pixels belonging to the current coding unit. The flag may then be set to “true” if the result of the sum is greater than a certain threshold T≧0, otherwise it may be set to “false”. Intra Test and Inter Test stages may then react to the flag value, e.g., by enabling or disabling specific coding modes for a current macroblock. For each coding mode that is disabled, the computational complexity associated to evaluating it will be saved, thus saving power consumption (e.g., in a h/w implementation) or gaining speed (e.g., in a s/w implementation).

In one or more embodiments, a set of all possible coding modes for a coding unit may be defined as set_all={ mode1, mode2, . . . , modeN}.

The possibility will exist of defining two sub-sets of coding modes (set_FG and set_BG), e.g., one which may be tested when the flag is false and another one which may be tested when the flag is true.

The two sets may be chosen so that:

set_FG⊂set_all

set_BG⊂set_all

set_FG∪set_BG=set_all

Two examples of procedures that can be implemented in view of possible application to, e.g., to Baseline profile H.264/AVC encoding (see ITU-T and ISO/IEC JTC1, “Advanced video coding for generic audiovisual services”, ISO/IEC 14496-10 (MPEG-4 Part 10) and ITU-T Rec. H.264) will now be detailed.

In the exemplary case considered,

set_all={Skip, Inter16×16, Intra4×4, Intra16×16}, where the first two modes are Inter and the last two are Intra: a generic H.264 encoder can support further coding modes, but Skip and Inter16×16 may be the two only coding modes left if motion estimation is disabled.

In one or more embodiments, two coding sets may be selected, e.g., as follows:

set_FG={Intra4×4, Intra16×16}

set_BG={Skip, Inter16×16}

If the BG/FG flag is set to true, meaning that the current CU belongs to the foreground, only the available Intra coding modes may be evaluated for the current coding unit, excluding the Inter coding modes and saving the corresponding computational complexity.

If the flag is set to false, meaning that the current CU belongs to the background, only the Inter coding modes may be evaluated for the current coding unit, excluding the Intra coding modes and saving the corresponding computational complexity.

In one or more embodiments, based on whether the coding units considered belong to the background or to the foreground of the digital video images, the encoding modes for the coding units belonging to the background may thus be selected out of the Inter coding modes available by excluding Intra coding modes, while the encoding modes for the coding units belonging to the foreground may be selected out of the Intra coding modes available by excluding Inter coding modes.

In one or more embodiments, the coding process may be simplified as follows:
all the coding units belonging to the foreground may be coded with Intra-frame prediction,
all the coding units belonging to the background may be coded with Inter-frame prediction with null motion vector.

While (slightly) more complex than an Intra-only encoder, a video encoder system configured to implement the exemplary procedure just discussed provides the possibility of exploiting Inter-frame prediction to encode the pixels corresponding to the background, with, e.g., zero movement from frame to frame. Compression in the background areas may be appreciably improved with respect to a pure Intra-only encoder.

For instance, in a video surveillance application the background areas may be expected to be much higher than the foreground and many frames in the input digital video frame may be expected to contain only background, so that the overall compression performance may be expected to improve significantly.

In one or more embodiments, two coding sets may be selected, e.g., as follows:

set_FG=set_all={Skip, Inter16×16, Intra4×4, Intra16×16}

set_BG={Skip, Inter16×16}

So if the BG/FG flag is set to true, meaning that the current CU belongs to the foreground, the encoder may test all the available coding modes, thus guaranteeing a good coding efficiency in the most relevant parts of the image.

If the flag is set to false, meaning that the current CU belongs to the background, only the Inter coding modes may be evaluated, thus decreasing the coding efficiency in the least important parts of the image.

In one or more embodiments, based on whether the coding units considered belong to the background or to the foreground of the digital video images, the encoding modes for the coding units belonging to the background may thus be selected out of the Inter coding modes available by excluding Intra coding modes, while the encoding modes for the coding units belonging to the foreground may be selected out of all the available Intra and Inter coding modes.

While more complex than the exemplary encoder discussed previously, a video encoder system configured to implement the exemplary procedure just discussed may guarantee a good coding quality in the foreground areas, that are of course more interesting than the background. In various possible applications, background areas may be expected to be higher and more frequent than foreground areas, so that complexity savings in background coding may lead to significant overall (e.g., average) complexity savings for the whole system.

FIG. 6 depicts an exemplary block diagram of a system architecture corresponding to an encoder of one or more embodiments discussed previously.

In the diagram, reference numerals 200 and 202 denote background modeling and background subtraction modules/functions adapted to generate a binary mask BM from the current image I as discussed previously. Reference numeral 206 denotes a Coding Unit (CU) selection circuit/function adapted to generate the BG/FG flag from the binary mask. Reference numeral 208 denotes a video encoder circuit/function adapted to generate a compressed stream CS encoded on the basis of the BG/FG flag and the no-motion information (MV=0), that is without proper motion estimation ME. The system of FIG. 6 may comprise circuitry such as one or more processors P, one or more memories M, discrete circuitry DC, such as one or more logic gates, transform circuits, state machines, etc., which may be used alone or in various combinations to implement various functionality of the system.

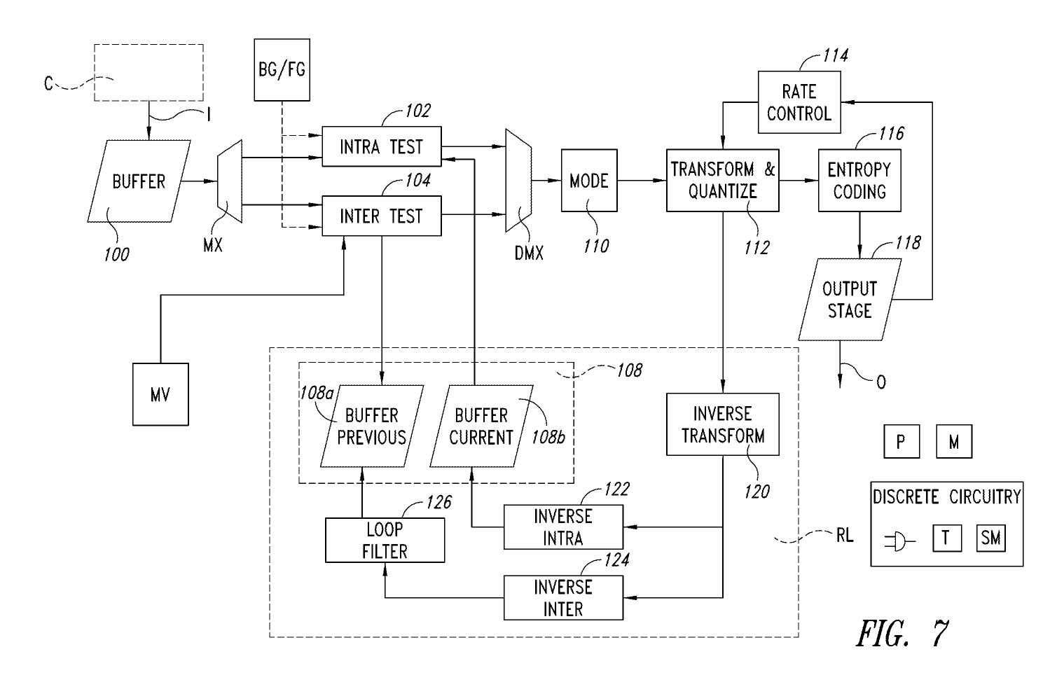

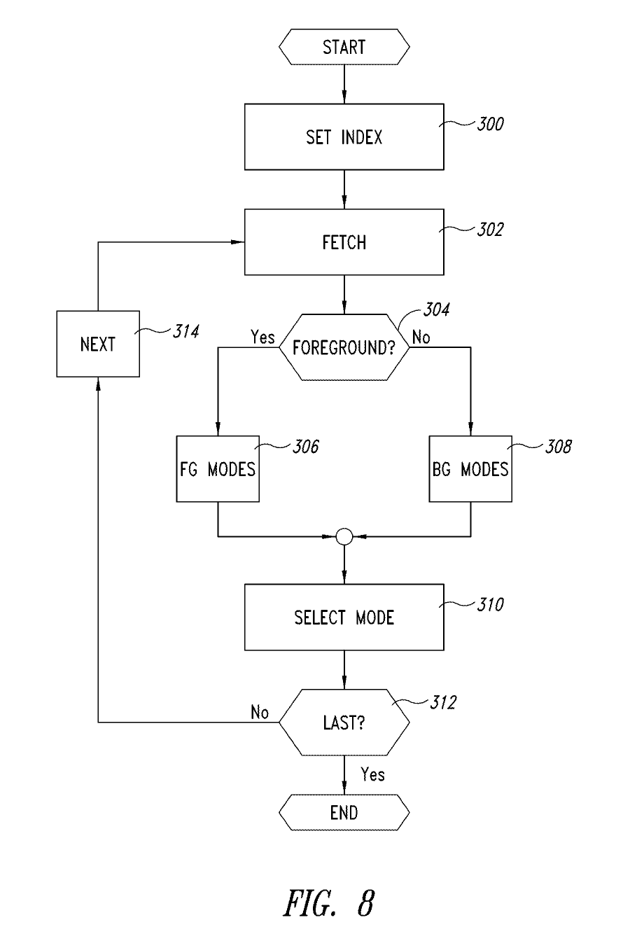

A corresponding exemplary video encoder system architecture is shown in FIG. 7.

In FIG. 7, circuits/functions corresponding to modules/functions already discussed in connection with FIGS. 1 and 2 are denoted with the same reference numerals. A corresponding description will not be repeated here for the sake of conciseness, being otherwise understood that circuits/functions indicated by a same reference numeral in FIGS. 1, 2 and 7 need not necessarily be implemented in the same way.

An encoder as exemplified in FIG. 7 may selectively enable or disable a set of possible coding modes for each coding unit, depending on the value of the input background/foreground flag BG/FG.

In one or more embodiments such encoder may not perform motion estimation, as the motion vectors MV for the Inter Tests 104 will expectedly be received from outside the encoder. In the first arrangement according to one or more embodiments as discussed previously, only no-motion information (e.g., null motion vector) may be provided. The system of FIG. 7 may comprise circuitry such as one or more processors P, one or more memories M, discrete circuitry DC, such as one or more logic gates, transform circuits T, state machines SM, etc., which may be used alone or in various combinations to implement various functionality of the system.

A corresponding coding process is exemplified by the flowchart of FIG. 8, where the steps indicated are the following:
START: process started
300: set image index n to 0
302: fetch Coding Unit for n, CU(n)
304: check if CU(n) belongs to foreground
306: if 304 yields YES, test (set_FG) coding modes
308; if 304 yields NO, test (set_BG) coding modes
310: select best coding mode
312: check if last CU in image
314: if 312 yields NO, increase n (n++) and return to 302;
END: if 312 yields YES, end of process

The second arrangement according to one or more embodiments as discussed previously is suitable for integration, e.g., in a smart camera having the capability to track movement as exemplified in FIG. 5. Such an approach may improve the capability of the encoder to compress moving areas by exploiting the information coming from the blob tracker module/function 205. In one or more embodiments such a tracker circuit/function may output, e.g., on a frame-by-frame basis, the updated position of each blob together with its speed (e.g., BPS).

In one or more embodiments, the displacements between the positions of the blobs in the previous frame and the current frame may be taken as a sparse object-based motion field in the current image; this sparse motion field can be converted in a block-based motion field adapted to be fed to the video encoder to perform the Inter-frame temporal prediction.

In one or more embodiments, the output of the blob tracker 205 may be used to initialize the motion estimation process for video encoding, thus reducing the overall amount of computation required. For each coding unit (or partition) belonging to a certain blob, motion estimation may be initialized by using the blob displacement information provided by the blob tracker, and then a reduced amount of motion vectors in the surrounding positions may be tested (in any known way for that purpose).

Also in this case, one or more embodiments may rely on the possibility of exploiting information coming from the movement detection stage, by separating the coding units in foreground (e.g., belonging to a certain blob) and in the background.

In one or more embodiments, the coding units belonging to the background may be coded with a mode chosen within a certain set_BG, without performing motion estimation.

In one or more embodiments, the coding units belonging to the foreground may be coded with a mode chosen within a certain set_FG, and the motion estimation will be performed as explained.

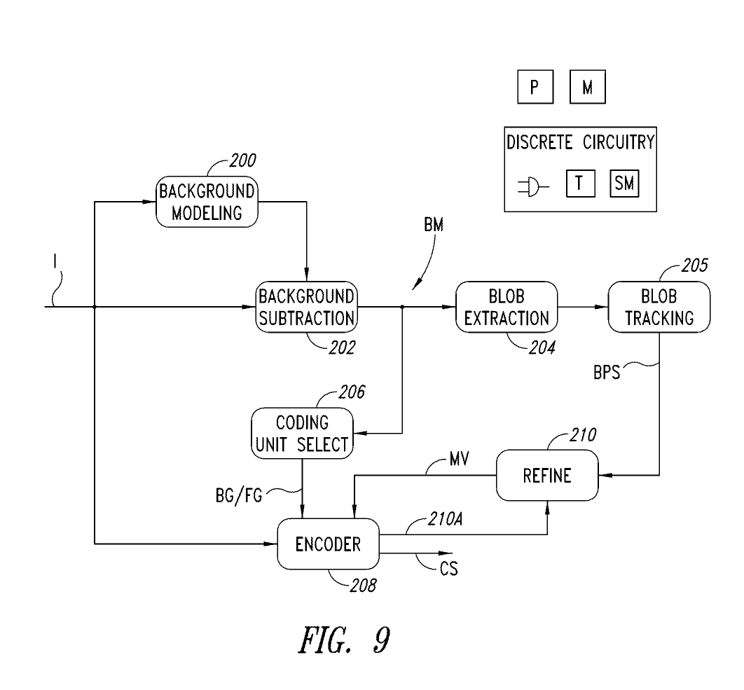

FIG. 9 shows an example of a corresponding block diagram. In FIG. 9, modules/functions corresponding to modules/functions already discussed in connection with, e.g., FIG. 5 are denoted with the same reference numerals. A corresponding description will not be repeated here for the sake of conciseness, being otherwise understood that circuitry/functions indicated by a same reference numeral, e.g., in FIGS. 5 and 9 need not necessarily be implemented in the same way.

Also, in the exemplary case of FIG. 9, a binary mask BM as provided by the background subtraction circuit/function 202 may be input to a “CU selection” circuit/function 206 to generate a flag indicative of whether the coding units considered belong to the background or to the foreground.

In the exemplary case of FIG. 9, a video encoder 208 may receive motion vectors MV as provided by a “motion refinement” circuit/function stage 210, which may perform a (simplified) motion estimation on the basis of the blob-based motion field produced by the blob tracker 205 as discussed previously, possibly on the basis of current image and reference image as provided by the encoder 208, e.g., on a line 210A. The system of FIG. 9 may comprise circuitry such as one or more processors P, one or more memories M, discrete circuitry DC, such as one or more logic gates, transform circuits T, state machines SM, etc., which may be used alone or in various combinations to implement various functionality of the system.

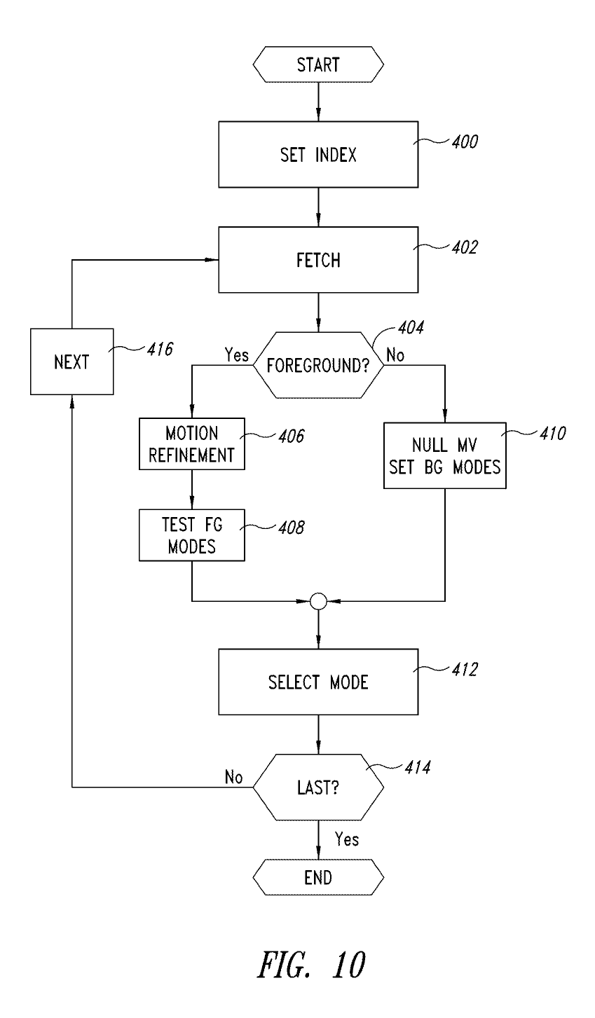

A corresponding coding process is exemplified by the flowchart of FIG. 10, where the steps indicated are the following:
START: process started
400: set image index n to 0
402: fetch Coding Unit for n, CU(n)
404: check if CU(n) belongs to foreground
406: if 404 yields YES, perform motion refinement and then test (set_FG) coding modes (at 408) with motion vectors MV;
410: if 404 yields NO, test (set_BG) coding modes with null MV
412: select best coding mode
414: check if last CU in image
414: if 414 yields NO, increase n (n++) and return to 402;
END: if 414 yields YES, end of process.

Experiments performed by the inventors involved, e.g., a set of video sequences in VGA format (640×480 pixels), representative of real video surveillance scenarios encoded conforming to H.264/AVC standard specifications (see ITU-T and ISO/IEC JTC1, “Advanced video coding for generic audiovisual services”, ISO/IEC 14496-10 (MPEG-4 Part 10) and ITU-T Rec. H.264) with a configuration in Baseline Profile mode with a single reference image corresponding to the immediately previous image of the sequence and an Intra-only image period of 30 images, corresponding to one Intra image per second.

Performance has been evaluated in terms of:
compression efficiency as average Y-PSNR (Peak Signal to Noise Ratio of the luminance component) vs. achieved bit-rate at given quantization steps;
computational complexity as user time used to complete the process.

In the experiments, exemplary embodiments as discussed with reference to FIGS. 6 to 10 were considered in comparison with the following configurations of a H.264 encoder:
Intra-only: only Intra-frame macroblock coding modes enabled. This configuration is a lower bound for implementation complexity and for compression efficiency, e.g., it is easy to implement but the compression provided may be poor;
Inter: all Intra-frame and Inter-frame coding modes enabled; motion estimation is performed with a fast standard algorithm as disclosed, e.g., in U.S. Pat. No. 6,891,891 B2. This configuration represents an upper bound for compression efficiency and also for implementation complexity, as it gives excellent compression against a fairly complex implementation.

The results of the experiments demonstrated that one or more embodiments may reduce complexity to a level comparable to an Intra-only solution while keeping compression efficiency in line with the efficiency of a full Inter solution.

Of course, without prejudice to the principles of the embodiments, the details of construction and the embodiments may vary, even significantly, with respect to what is illustrated herein purely by way of non-limiting example, without thereby departing from the extent of protection.

Some embodiments may take the form of or include computer program products. For example, according to one embodiment there is provided a computer readable medium including a computer program adapted to perform one or more of the methods or functions described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some of the systems and/or modules and/or circuits and/or blocks may be implemented or provided in other manners, such as at least partially in firmware and/or hardware, including, but not limited to, one or more application-specific integrated circuits (ASICs), digital signal processors, discrete circuitry, logic gates, shift registers, standard integrated circuits, state machines, look-up tables, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
dividing a sequence of digital video images into coding units;
classifying coding units into background coding units and foreground coding units;
selecting encoding modes for coding units from a set of available encoding modes including a subset of Inter encoding modes having null motion vectors and a subset of Intra encoding modes, wherein encoding modes selected for coding units classified as background coding units are selected from the subset of Inter encoding modes having null motion vectors; and
encoding coding units using selected encoding modes.

2. The method of claim 1, comprising:
selecting encoding modes for coding units classified as foreground encoding units from the subset of Intra encoding modes.

3. The method of claim 1, comprising:
selecting encoding modes for coding units classified as foreground encoding units from the set of available encoding modes.

4. The method of claim 1, comprising:
summing values of pixels of a coding unit;
comparing the sum to a threshold value; and
classifying the coding unit based on the comparison.

5. The method of claim 1 wherein selecting encoding modes for coding units classified as background coding units includes disabling specific coding modes of the subset of Inter encoding modes for a current coding unit.

6. The method of claim 1, comprising:
applying blob extraction and tracking to frames of the sequence of digital video images;
generating a block-based motion field based on the blob extraction and tracking; and
encoding at least some coding units of the sequence of digital video images using Inter temporal prediction based on the block-based motion field.

7. The method of claim 6, comprising:
initializing video-encoding motion estimation based on the blob tracking.

8. The method of claim 7, comprising:
testing a set of motion vectors based on the blob tracking.

9. A device, comprising:
an input configured to receive digital video images; and
image processing circuitry configured to:
divide digital video images into coding units;
classify coding units into background coding units and foreground coding units;
select encoding modes for coding units from a set of available encoding modes including a subset of Inter encoding modes having null motion vectors and a subset of Intra encoding modes, wherein the image processing circuitry is configured to select encoding modes for coding units classified as background coding units from the subset of Inter encoding modes having null motion vectors; and
encode coding units using selected encoding modes.

10. The device of claim 9 wherein the image processing circuitry is configured to select encoding modes for coding units classified as foreground encoding units from the subset of Intra encoding modes.

11. The device of claim 9 wherein the image processing circuitry is configured to select encoding modes for coding units classified as foreground encoding units from the set of available encoding modes.

12. The device of claim 9 wherein the image processing circuitry is configured to:
sum values of pixels of a coding unit;
compare the sum to a threshold value; and
classify the coding unit based on the comparison.

13. The device of claim 9 wherein the image processing circuitry is configured to selectively disable encoding modes of the subset of Inter encoding modes for coding units classified as background coding units.

14. The device of claim 9 wherein the image processing circuitry is configured to:
apply blob extraction and tracking to frames of a sequence of digital video images;
generate a block-based motion field based on the blob extraction and tracking; and
encode at least some coding units of the sequence of digital video images using Inter temporal prediction based on the block-based motion field.

15. The device of claim 14 wherein the image processing circuitry is configured to:
initialize video-encoding motion estimation based on the blob tracking.

16. The device of claim 15 wherein the image processing circuitry is configured to:
test a set of motion vectors based on the blob tracking.

17. A system, comprising:
an image capture device configured to capture a sequence of video images; and
image processing circuitry coupled to the image capture device and configured to:
divide the sequence of digital video images into coding units;
classify coding units into background coding units and foreground coding units;
select encoding modes for coding units from a set of available encoding modes including a subset of Inter encoding modes having null motion vectors and a subset of Intra encoding modes, wherein the image processing circuitry is configured to select encoding modes for coding units classified as background coding units from the subset of Inter encoding modes having null motion vectors; and
encode coding units using selected encoding modes.

18. The system of claim 17 wherein the image processing circuitry is configured to select encoding modes for coding units classified as foreground encoding units from the set of available encoding modes.

19. The system of claim 17 wherein the image processing circuitry is configured to:
sum values of pixels of a coding unit;
compare the sum to a threshold value; and
classify the coding unit based on the comparison.

20. The system of claim 17 wherein the image processing circuitry is configured to:
apply blob extraction and tracking to frames of the sequence of digital video images;
generate a block-based motion field based on the blob extraction and tracking; and
encode at least some coding units of the sequence of digital video images using Inter temporal prediction based on the block-based motion field.

21. A non-transitory computer-readable medium whose contents configure an image processing device to perform a method, the method comprising:
dividing a sequence of digital video images into coding units;
classifying the coding units into background coding units and foreground coding units;
selecting encoding modes for coding units from a set of available encoding modes including a subset of Inter encoding modes having null motion vectors and a subset of Intra encoding modes, wherein encoding modes selected for coding units classified as background coding units are selected from the subset of Inter encoding modes having null motion vectors; and
encoding the coding units using the selected encoding modes.

22. The non-transitory computer-readable medium of claim 21 wherein the method comprises selecting encoding modes for coding units classified as foreground encoding units from the subset of Intra encoding modes.

23. The non-transitory computer-readable medium of claim 21 wherein the method comprises:
summing values of pixels of a coding unit;
comparing the sum to a threshold value; and
classifying the coding unit based on the comparison.

24. The non-transitory computer-readable medium of claim 21 wherein the method comprises:
applying blob extraction and tracking to frames of the sequence of digital video images;
generating a block-based motion field based on the blob extraction and tracking; and
encoding at least some coding units of the sequence of digital video images using Inter temporal prediction based on the block-based motion field.
